(19) United States
(12) Patent Application Publication
(10) Pub. No.: US 2019/0317350 A1
(43) Pub. Date: Oct. 17, 2019

(54) LIQUID CRYSTAL DISPLAY DEVICE AND METHOD FOR DRIVING LIQUID CRYSTAL DISPLAY DEVICE

(71) Applicant: SAKAI DISPLAY PRODUCTS CORPORATION, Sakai-shi, Osaka (JP)

(72) Inventor: RYUSUKE HORIBE, Sakai-shi, Osaka (JP)

(73) Assignee: SAKAI DISPLAY PRODUCTS CORPORATION, Sakai-shi, Osaka (JP)

(21) Appl. No.: 16/343,360

(22) PCT Filed: Oct. 26, 2016
(86) PCT No.: PCT/JP2016/081765

§ 371 Date: Jun. 24, 2019

(51) Int. Cl. G02F 1/133; G09G 3/36; G02F 1/1362; G02F 1/1368

(52) U.S. Cl. CPC G02F 1/13306; G09G 3/3677; G09G 2300/0426; G02F 1/1368; G09G 2310/08; G02F 1/136286

(57) ABSTRACT

Provided are a liquid crystal display device and a method for driving a liquid crystal display device capable of reducing the influence of a voltage drop attributable to wiring resistance in a display panel without previously setting a voltage value by statistical processing in the design stage. The liquid crystal display device includes: a plurality of gate drivers connected to gate lines at a first edge of a substrate; a plurality of source drivers connected to source lines at a second edge of the substrate; a power supply unit; and a single first wire used to apply, to the plurality of gate drivers, a voltage for driving the gate drivers, wherein the plurality of gate drivers are arranged at the first edge of the substrate in a second direction and connected to the power supply unit through the first wire in order from the nearest side to the furthest side of the power supply unit, and the liquid crystal display device includes a voltage control unit that maintains the value of the voltage applied to the gate driver furthest from the power supply unit at a predetermined voltage value.

### TECHNICAL FIELD

The present invention relates to a liquid crystal display device and a method for driving a liquid crystal display device.

### BACKGROUND ART

In recent years, in accordance with increase in size of a liquid crystal display panel, a liquid crystal display device including a plurality of gate drivers and source drivers has been proposed. In such a liquid crystal display device, when a part of a power supply line connecting a power supply section and each gate driver to each other is provided within a liquid crystal display panel, a voltage drop occurs in a partial line section within the liquid crystal display panel. Therefore, a difference is caused among applied voltages supplied to the respective gate drivers, which may affect screen display.

Patent Literature 1 discloses a configuration in which a voltage value of a voltage to be supplied to a power supply line is changed in a stepwise manner at timing of each gate driver performing a scanning operation so as to make substantially constant the values of gate drive voltages output from the respective gate drivers in performing the scanning operation.

### CITATION LIST

### Patent Literature

### [Patent Literature 1]

Japanese Patent Application Laid-Open Publication No. 2009-8942

### SUMMARY OF INVENTION

### Technical Problem

The wiring resistance caused in a display panel is, however, varied depending on the size of the panel, and hence, there is a problem that the voltage value to be changed in a stepwise manner needs to be set by statistically obtaining an optimal value every time a panel is developed.

Besides, even in the same type of display panels, the wiring resistance is varied depending on variation or the like occurring in production. Furthermore, even in one and the same display panel, the wiring resistance is varied due to influence of change over time and temperature change.

Therefore, when the voltage value to be changed in a stepwise manner is set to a fixed value as disclosed in Patent Literature 1, the change over time of the wiring resistance cannot be coped with, and hence, power supply voltages supplied to respective gate drivers or gate drive signals output from the respective gate drivers may be varied, which may appear on screen display.

The present invention was devised in consideration of these circumstances, and an object is to provide a liquid crystal display device and a method for driving a liquid crystal display device with which influence of a voltage drop due to wiring resistance within a display panel can be reduced without precedently setting a voltage value by performing statistic processing at the design stage.

### Solution to Problem

A liquid crystal display device according to one embodiment of the present invention includes: a display panel including a substrate having a surface on which a plurality of pixels are formed in a matrix defined by a first direction and a second direction, a plurality of gate lines are disposed along the first direction, and a plurality of source lines are disposed along the second direction; a plurality of gate drivers connected to the gate lines on a first side of the substrate; a plurality of source drivers connected to the source lines on a second side of the substrate; a power supply section; and a single first line used for applying, to each of the gate drivers, a supply voltage for operating the plurality of gate drivers, and the plurality of gate drivers are disposed on the first side of the substrate along the second direction, and are connected to the power supply section through the first line in a near-to-far order from the power supply section, the first line is formed, in a partial section thereof, on the surface of the substrate, and the liquid crystal display device includes a voltage controller controlling, to a prescribed voltage value, a value of an applied voltage to the gate driver furthest from the power supply section.

A method for driving a liquid crystal display device according to the embodiment of the present invention is a method for driving a liquid crystal display device including: a display panel including a substrate having a surface on which a plurality of pixels are formed in a matrix defined by a first direction and a second direction, a plurality of gate lines are disposed along the first direction, and a plurality of source lines are disposed along the second direction; a plurality of gate drivers connected to the gate lines on a first side of the substrate; a plurality of source drivers connected to the source lines on a second side of the substrate; a power supply section; and a single first line used for applying, to each of the gate drivers, a supply voltage for operating the plurality of gate drivers, the plurality of gate drivers being disposed on the first side of the substrate along the second direction, and being connected to the power supply section through the first line in a near-to-far order from the power supply section, the first line being formed, in a partial section thereof, on the surface of the substrate, and the method includes: calculating a difference between a value of an applied voltage to the gate driver furthest from the power supply section and a prescribed voltage value; and controlling the value of the applied voltage to the prescribed voltage value by changing an output voltage of the power supply section in accordance with the calculated difference.

### Advantageous Effects of Invention

According to the embodiment of the present invention, the influence of a voltage drop due to wiring resistance within a display panel can be reduced without precedently setting a voltage value by performing statistic processing at the design stage.

### BRIEF DESCRIPTION OF DRAWINGS

FIG. 1 is a schematic diagram illustrating a schematic configuration of a liquid crystal display device according to a first embodiment.

FIG. 2 is a schematic diagram used for describing a configuration of a liquid crystal display device according to a comparative example.

FIG. 3A is a waveform diagram illustrating change over time of an applied voltage applied to a power supply of each gate driver in the comparative example.

FIG. 3B is another waveform diagram illustrating the change over time of the applied voltage applied to the power supply of each gate driver in the comparative example.

FIG. 3C is another waveform diagram illustrating the change over time of the applied voltage applied to the power supply of each gate driver in the comparative example.

FIG. 3D is another waveform diagram illustrating the change over time of the applied voltage applied to the power supply of each gate driver in the comparative example.

FIG. 4 is a waveform diagram illustrating change over time of a monitor voltage not controlled.

FIG. 5 is a block diagram illustrating a configuration of a voltage controller according to the first embodiment.

FIG. 6 is a block diagram illustrating an exemplified configuration of a controller included in the voltage controller.

FIG. 7 is a waveform diagram illustrating change over time of the monitor voltage controlled.

FIG. 8 is a block diagram illustrating a configuration of a voltage controller according to a second embodiment.

FIG. 9 is a block diagram illustrating a configuration of a voltage controller according to a third embodiment.

FIG. 10 is a block diagram illustrating a configuration of a power supply section according to a fourth embodiment.

FIG. 11 is a waveform diagram used for describing sampling timing of the monitor voltage.

### DESCRIPTION OF EMBODIMENTS

Embodiments of the present invention will now be specifically described with reference to the accompanying drawings.

### First Embodiment

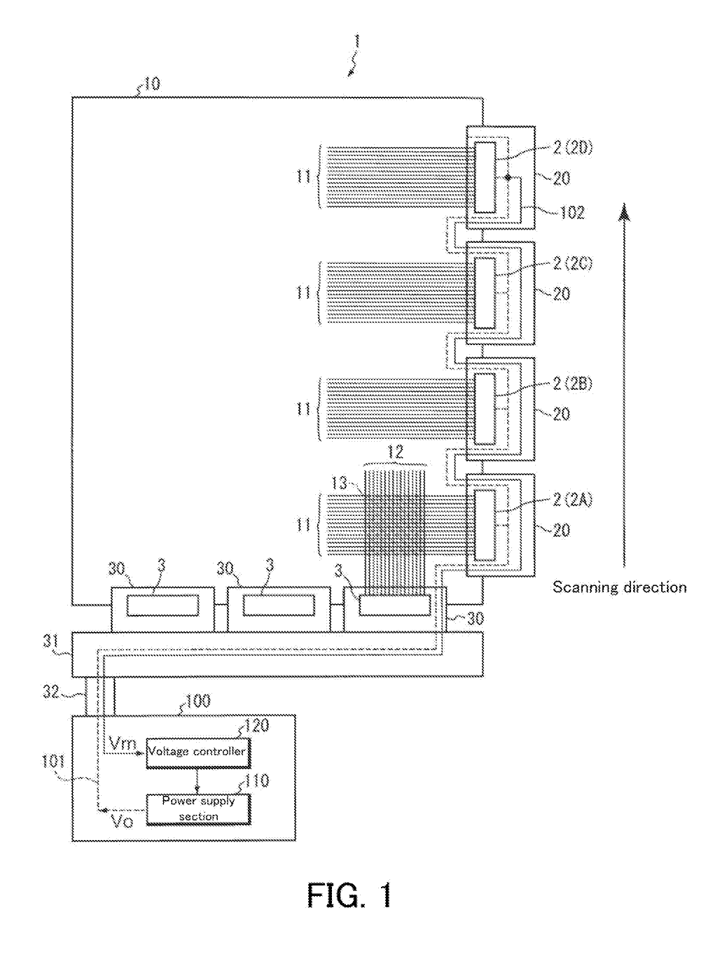

FIG. 1 is a schematic diagram illustrating a schematic configuration of a liquid crystal display device according to a first embodiment. The liquid crystal display device according to the first embodiment includes a rectangular liquid crystal display panel 1, a plurality of gate drivers 2 provided along a first side (a right side in an example illustrated in FIG. 1) of the liquid crystal display panel 1, a plurality of source drivers 3 provided along a second side (a lower side in the example illustrated in FIG. 1) of the liquid crystal display panel 1, a timing controller 100 for driving the gate drivers 2 and the source drivers 3, and the like.

Although four gate drivers 2 and three source drivers 3 are illustrated in the exemplified liquid crystal display device of FIG. 1, the numbers of the gate drivers 2 and the source drivers 3 are not limited to the numbers illustrated in FIG. 1. In the following description, when the four gate drivers 2 are respectively distinguishably described, they will be referred to as the gate drivers 2A, 2B, 2C, and 2D in an order of the nearest to the furthest ones from the timing controller 100.

The liquid crystal display panel 1 includes a TFT (Thin Film Transistor) substrate 10 on which a plurality of gate lines 11 are disposed along a first direction (a direction perpendicular to a scanning direction illustrated in the drawing), and on the TFT substrate 10, a plurality of source lines 12 are also disposed along a second direction (the scanning direction illustrated in the drawing). Besides, on the TFT substrate 10 included in the liquid crystal display panel 1, a plurality of pixels 13 formed in the form of a matrix defined by the first direction and the second direction are provided. Each pixel 13 includes a liquid crystal layer disposed between a pixel electrode and a counter electrode, a TFT connected to corresponding ones of the gate lines 11 and the source lines 12, and the like.

Each of the gate drivers 2 formed respectively on film substrates 20 attached to the first side of the liquid crystal display panel 1 is connected to a corresponding one of the gate lines 11, and outputs, to the gate line 11, a scanning signal for on/off control of the TFT of each of the pixels 13 at timing controlled by the timing controller 100.

Each of source drivers 3 formed respectively on film substrates 30 attached to the second side of the liquid crystal display panel 1 is connected to a corresponding one of the source lines 12, and outputs, to the source line 12, a video signal to be supplied to each of the pixels 13 at timing controlled by the timing controller 100.

The timing controller 100 includes a power supply section 110 outputting applied voltages to be applied to the gate drivers 2 and the source drivers 3, and a voltage controller 120 controlling a voltage value of each applied voltage output by the power supply section 110, and outputs the applied voltages to the gate drivers 2 and the source drivers 3 at scanning timing for driving the gate drivers 2 and the source drivers 3. Incidentally, the timing controller 100 is connected to the respective source drivers 3 through source power supply lines (not shown) formed on a source substrate 31 and a flat cable 32, and the timing controller 100 is connected to the respective gate drivers 2 in a near-to-far order from the power supply section 110, so as to successively connect power supplies for operating the respective drivers through a single gate power supply line (first line) 101. The gate power supply line 101 is formed, in a partial section thereof, as a wiring layer within the TFT substrate 10 (disposed on the surface of the TFT substrate 10).

Besides, the liquid crystal display device according to the present embodiment includes a voltage monitor line (second line) 102 connecting a wiring region for applying the applied voltage to the furthest gate driver 2D and the voltage controller 120 to each other. The voltage monitor line 102 is formed, similarly to the gate power supply line 101, in a partial section thereof, as a wiring layer within the TFT substrate 10 (disposed on the surface of the substrate), and wired to the voltage controller 120 without being connected to any other gate drivers 2. The voltage controller 120 controls, based on a signal from the wiring region obtained through the voltage monitor line 102 (hereinafter referred to as the voltage monitor signal), the power supply section 110 so that the value of the applied voltage to be applied to the furthest gate driver 2D can be a prescribed voltage value.

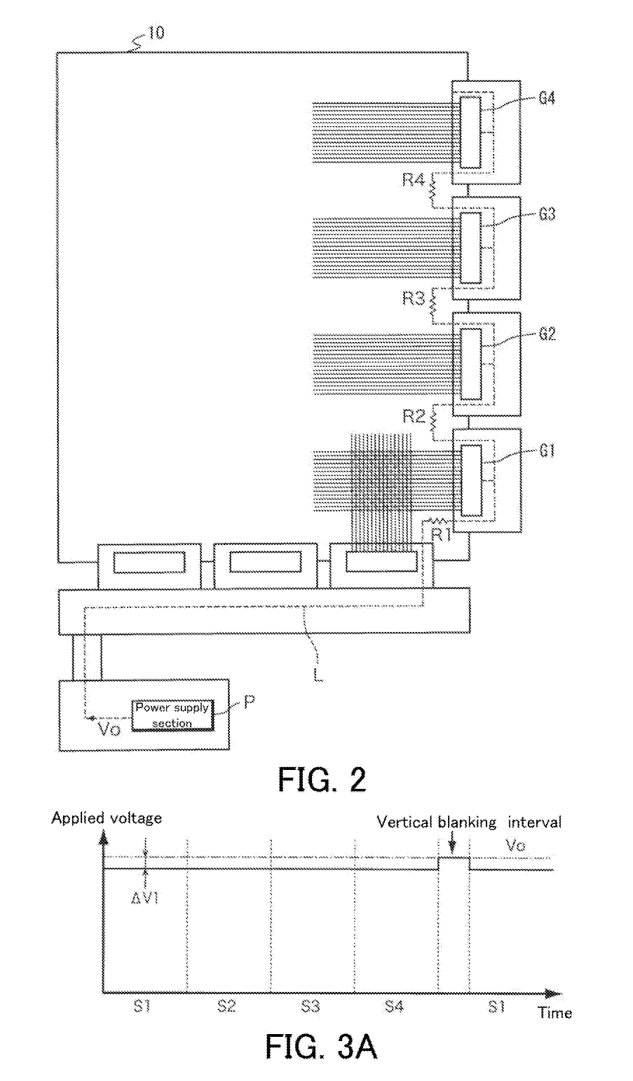

Before describing an operation of the liquid crystal display device according to the present embodiment, an operation of a liquid crystal display device of a comparative example will be described. FIG. 2 is a schematic diagram illustrating a configuration of the liquid crystal display device of the comparative example. The liquid crystal display device of the comparative example includes, similarly to the liquid crystal display device according to the present embodiment, a liquid crystal display panel, a plurality of source drivers, a plurality of gate drivers G1 to G4, a timing controller and the like. The respective gate drivers G1 to G4 are connected through a gate power supply line L to a power supply section P included in a timing controller, and are configured to operate using power supply voltage applied by the power supply section P.

The gate power supply line L connecting the power supply section P to the gate drivers G1 to G4 is formed, in a partial section thereof, as a wiring layer within the TFT substrate 10. In the example illustrated in FIG. 2, the gate power supply line L is formed in the form of the wiring layer within the TFT substrate 10 in its portions between the power supply section P and the gate driver G1 nearest to the power supply section P, and between the adjacent gate drivers G1-G2, G2-G3, and G3-G4. The wiring resistance of the gate power supply line L is about 10Ω in its portion excluding the wiring layer within the TFT substrate 10 (namely, a line portion formed on a source substrate and a film substrate), but within the TFT substrate 10, the wiring layer is formed as a thin film of, for example, about 4000 angstroms, and hence its wiring resistance is about 100 to 200Ω. As a result, when the power supply voltage is supplied to each of the gate drivers G1 to G4, a voltage drop occurs in the wiring layer within the TFT substrate 10.

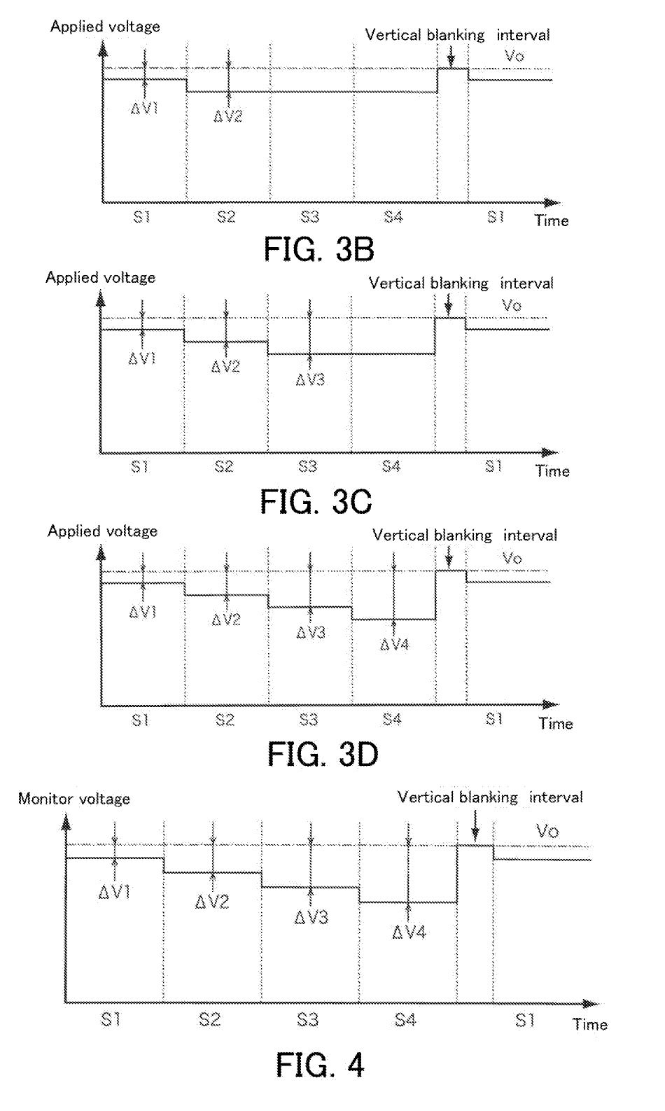

FIGS. 3A to 3D are waveform diagrams illustrating change over time of the applied voltage applied to each gate driver in the comparative example. In the waveform diagrams of FIGS. 3A to 3D, the abscissa indicates the time, and the ordinate indicates the voltage value. FIG. 3A illustrates the change over time of the applied voltage on a connection point to the gate power supply line L in the film substrate on which the gate driver G1 nearest to the power supply section P is formed. For example, when the applied voltage having a voltage value Vo is output from the power supply section P for driving the nearest gate driver G1 in a period S1, a voltage drop of ΔV1 (=R1×I) occurs in the period S1 due to a current I flowing through the gate power supply line L. Here, R1 denotes a value of the resistance (wiring resistance) in the wiring layer within the TFT substrate 10 immediately before the film substrate on which the gate driver G1 is formed (see FIG. 2),

FIG. 3B illustrates the change over time of the applied voltage on a connection point between the gate driver G2 second nearest to the power supply section P and the gate power supply line L. When the applied voltage having the voltage value Vo is output from the power supply section P for driving the second nearest gate driver G2 in a period S2 following the period S1, a voltage drop of ΔV2 (=(R1+R2)×I) occurs in the period S2 due to the current I flowing through the gate power supply line L. Here, R2 denotes a value of the wiring resistance between the two film substrates on which the gate drivers G1 and G2 are respectively formed (see FIG. 2).

FIG. 3C illustrates the change over time of the applied voltage on a connection point between the gate driver G3 third nearest to the power supply section P and the gate power supply line L. When the applied voltage having the voltage value Vo is output from the power supply section P for driving the third nearest gate driver G3 in a period S3 following the period S2, a voltage drop of ΔV3 (=(R1+R2+R3)×I) occurs in the period S3 due to the current I flowing through the gate power supply line L. Here, R3 denotes a value of the wiring resistance between the two film substrates on which the gate drivers G2 and G3 are respectively formed (see FIG. 2).

FIG. 3D illustrates the change over time of the applied voltage on a connection point between the gate driver G4 furthest from the power supply section P and the gate power supply line L. When the applied voltage having the voltage value Vo is output from the power supply section P for driving the furthest gate driver G4 in a period S4 following the period S3, a voltage drop of ΔV4 (=(R1+R2+R3+R4)×I) occurs in the period S4 due to the current I flowing through the gate power supply line L. Here, R4 denotes a value of the wiring resistance between the two film substrates on which the gate drivers G3 and G4 are respectively formed (see FIG. 2).

In this manner, in the liquid crystal display device of the comparative example, a voltage drop in accordance with the value of the wiring resistance of the gate power supply line L occurs, and therefore, even when the voltage value of the voltage output from the power supply section P is constant, the amplitudes of the applied voltages respectively applied to the power supplies of the gate drivers G1 to G4 are varied. As a result, peak values of gate drive signals output from the respective gate drivers G1 to G4 are varied, resulting in causing a phenomenon of gate block separation or the like, which affects screen display.

In order to overcome this problem, Patent Literature 1 mentioned above discloses the method in which a voltage value of a voltage to be supplied from a power supply section is precedently set in a stepwise manner so that the amplitudes of applied voltages applied to the power supplies of the respective operating gate drivers can be substantially constant, among the gate drivers, at timing of each gate driver performing a scanning operation. In the method disclosed in Patent Literature 1, however, it is necessary to precedently set the value of the voltage to be output from the power supply section, and therefore, when the wiring resistance within the TFT substrate 10 is varied depending on the type, the panel size or the like, an optimal value of the output voltage should be newly obtained for setting. Besides, even in using one and the same liquid crystal display panel, the wiring resistance may be varied due to change over time, temperature change and the like, but such change over time of the wiring resistance cannot be coped with by the method of Patent Literature 1 in which the output voltage is precedently set.

On the contrary, in the liquid crystal display device according to the present embodiment, the voltage monitor line 102 is used for monitoring a voltage (hereinafter also referred to as the monitor voltage) on the gate power supply line 101 (wiring region) in the film substrate 20 on which the gate driver 2D furthest from the power supply section 110, and control is performed so as to cause the monitor voltage to have a prescribed voltage value. Here, the wiring region to be monitored may be any region of a wiring range disposed within the film substrate 20 on which the furthest gate driver 2D is formed, and is not limited to the connection point between the furthest gate driver 2D and the voltage monitor line 102.

FIG. 4 is a waveform diagram illustrating change over time of the monitor voltage not controlled. In the waveform diagram of FIG. 4, the ordinate indicates the time, and the abscissa indicates the magnitude of the monitor voltage. It is noted that the change over time of the monitor voltage not controlled by the voltage controller 120 is illustrated in FIG. 4.

In the operation of the gate driver 2A nearest to the power supply section 110 in the period S1, when the current I flows through a partial section (wiring resistance R1) within the TFT substrate 10 in the gate power supply line 101 connecting the power supply section 110 and the nearest gate driver 2A to each other, a voltage drop of ΔV1 (=R1×I) occurs. The voltage controller 120 can detect the value ΔV1 of this voltage drop as a difference between the value Vo of the applied voltage to the gate driver 2A and a value Vm of the monitor voltage.

In the operation of the gate driver 2B second nearest to the power supply section 110 in the period S2, when the current I flows through, in addition to the above-described partial section, a partial section (wiring resistance R2) within the TFT substrate 10 in the gate power supply line 101 present between the two gate drivers 2A and 2B, a voltage drop of ΔV2 (=(R1+R2)×I) occurs. The voltage controller 120 can detect the value ΔV2 of this voltage drop as a difference between the value Vo of the applied voltage to the gate driver 2B and the value Vm of the monitor voltage.

In the operation of the gate driver 2C third nearest to the power supply section 110 in the period S3, when the current I flows through, in addition to the above-described partial sections, a partial section (wiring resistance R3) within the TFT substrate 10 in the gate power supply line 101 present between the two gate drivers 2B and 2C, a voltage drop of ΔV3 (=(R1+R2+R3)×I) occurs. The voltage controller 120 can detect the value ΔV3 of this voltage drop as a difference between the value Vo of the applied voltage to the gate driver 2C and the value Vm of the monitor voltage.

In the operation of the gate driver 2D furthest from the power supply section 110 in the period S4, when the current I flows through, in addition to the above-described partial sections, a partial section (wiring resistance R4) within the TFT substrate 10 in the gate power supply line 101 present between the two gate drivers 2C and 2D, a voltage drop of ΔV4 (=(R1+R2+R3+R4)×I) occurs. The voltage controller 120 can detect the value ΔV4 of this voltage drop as a difference between the value Vo of the applied voltage to the gate driver 2D and the value Vm of the monitor voltage.

The voltage controller 120 according to the present embodiment controls the power supply section 110 so that the value of the applied voltage applied to the power supply of each of the gate drivers 2A to 2D can be a prescribed voltage value (target voltage value Vref) by changing the value of the voltage to be output by the power supply section 110 at the operation timing of the gate drivers 2A to 2D in accordance with a difference between the target voltage value Vref and the value Vm of the monitor voltage.

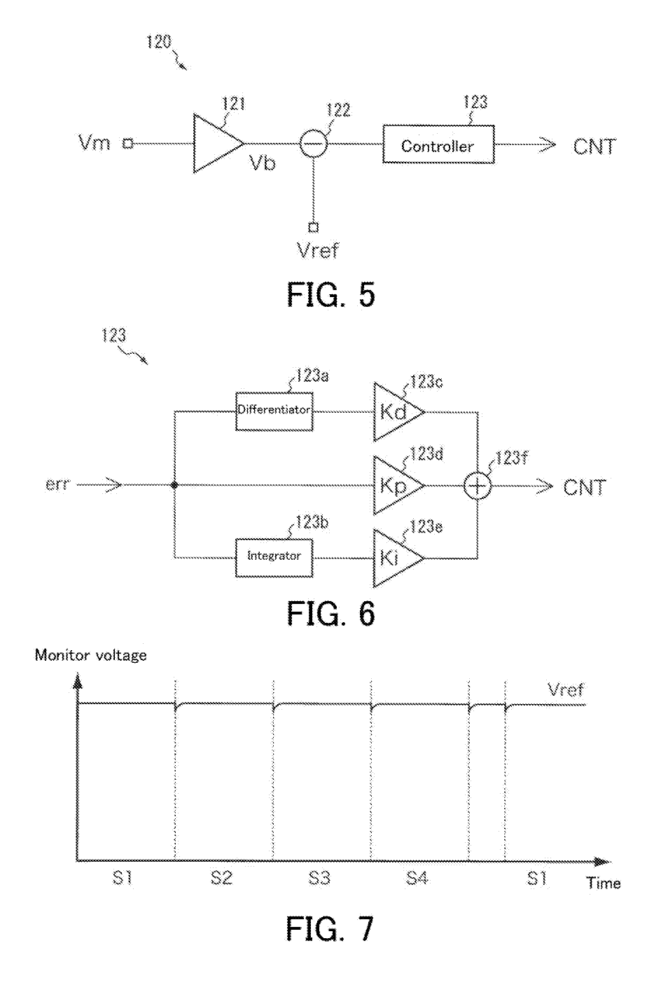

FIG. 5 is a block diagram illustrating a configuration of the voltage controller 120 according to the first embodiment, and FIG. 6 is a block diagram illustrating an exemplified configuration of a controller 123 included in the voltage controller 120. The voltage controller 120 of the first embodiment includes an impedance converter 121, a subtractor 122, and the controller 123. The impedance converter 121 is, for example, a voltage follower, and receives a voltage monitor signal Vm input through the voltage monitor line 102 at high impedance to convert it into a signal Vb at low impedance. Input impedance of the impedance converter 121 is preferably higher than a resistance value of the voltage monitor line 102 sufficiently (for example, at least by 1000 times). A partial section of the voltage monitor line 102 is formed within the TFT substrate 10 (on the surface of the TFT substrate), and a voltage drop occurs when a current flows through the wiring layer formed within the TFT substrate 10, and therefore, the applied voltage applied to the furthest gate driver 2D cannot be accurately detected. Therefore, in the present embodiment, in order to reduce the influence of the voltage drop occurring in the wiring layer formed within the TFT substrate 10 to accurately detect the value of the applied voltage applied to the furthest gate driver 2D, the impedance converter 121 is provided at an input stage of the voltage controller 120 so as to detect the voltage monitor signal at high impedance, and thus, a current flowing through the voltage monitor line 102 is minimized to minimize a detection error. The impedance converter 121 outputs a signal obtained by converting the voltage monitor signal to the subtractor 122 disposed at the subsequent stage.

The subtractor 122 calculates a difference err between the voltage value Vb of the signal input from the impedance converter 121 and the target voltage value Vref, and outputs the calculated difference err to the controller 123. Here, the target voltage value Vref is a value precedently set for controlling the value of the applied voltage to the furthest gate driver to the prescribed voltage value.

The controller 123 includes a differentiator 123a, an integrator 123b, gains 123c to 123e, and an adder 123f, and performs PID control of the value of the applied voltage to the furthest gate driver 2D based on the difference err input from the subtractor 122. The differentiator 123a calculates a time change (differential) of the difference err input from the subtractor 122. The integrator 123b calculates an integral of the difference err input from the subtractor 122. The adder 123f adds all of a value obtained by multiplying the difference err by a constant Kp set by the gain 123d, a value obtained by multiplying the output of the differentiator 123a by a constant Kd set by the gain 123c, and a value obtained by multiplying the output of the integrator 123b by a constant Ki set by the gain 123e. Here, the constants Kp, Kd, and Ki of the gains 123c to 123e are precedently set. The voltage controller 120 outputs, to the power supply section 110, a value CNT obtained by the adder 123f.

The power supply section 110 outputs, based on a control output from the voltage controller 120, the applied voltages to the respective gate drivers 2A to 2D so as to obtain the voltage value Vo at the timing when each of the gate drivers 2A to 2D performs the scanning operation. Owing to the configuration described so far, in the present embodiment, the value Vm of the monitor voltage monitored through the voltage monitor line 102 can be controlled to be the constant target voltage value Vref.

FIG. 7 is a waveform diagram illustrating the change over time of the monitor voltage thus controlled. In the waveform diagram of FIG. 7, the abscissa indicates the time, and the ordinate indicates the magnitude of the monitor voltage. When the PID control by the voltage controller 120 is not performed, the applied voltages applied to the gate drivers 2A to 2D exhibit voltage drops as illustrated in FIG. 4 mainly due to the influence of the wiring resistance within the TFT substrate 10. On the contrary, in the present embodiment, since the voltage controller 120 performs feedback control based on the value Vm of the monitor voltage, the value of the applied voltage applied to the furthest gate driver 2D is controlled to a constant value (the target voltage value Vref), and the supply voltages to the respective gate drivers at the timing when the gate drivers 2A to 2D perform the scanning operation are controlled to be constant.

As described so far, in the first embodiment, even when the wiring resistance within the TFT substrate 10 is varied owing to the size of the liquid crystal display panel 1 and variation caused in production of the panel, the applied voltages applied when the gate drivers 2A to 2D perform the scanning operation can be controlled to be constant without precedently setting the values of the applied voltages to the gate drivers 2A to 2D at the design stage. As a result, in the present embodiment, the influence of a voltage drop caused due to the wiring resistance within the TFT substrate 10 can be reduced, and screen display quality can be improved.

### Second Embodiment

In a second embodiment, a configuration including a noise eliminator that eliminates noise from the signal output by the impedance converter 121 will be described.

It is noted that the whole configuration of the liquid crystal display device will not be described because the configuration is the same as that of the first embodiment.

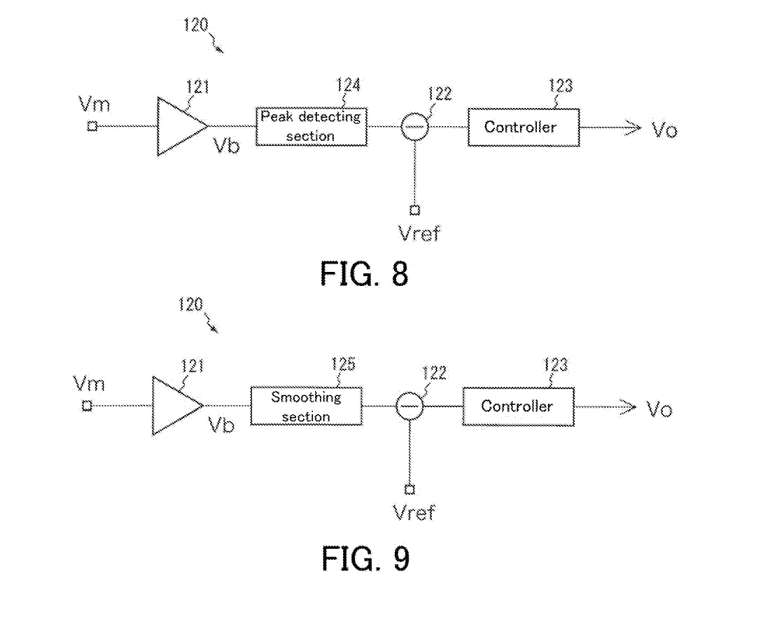

FIG. 8 is a block diagram illustrating the configuration of the voltage controller 120 according to the second embodiment. The voltage controller 120 of the second embodiment includes a peak detecting section 124 corresponding to the noise eliminator in addition to the impedance converter 121, the subtractor 122, and the controller 123 described above.

The peak detecting section 124 detects a peak of the signal output from the impedance converter 121 and outputs the thus obtained detection result to eliminate high frequency noise included in the signal. The peak detecting section 124 is configured by, for example, a detector circuit. Since high frequency noise occurs mainly in a cycle of a horizontal period, a time constant of the peak detecting section 124 is preferably set to a time sufficiently longer than the cycle of the horizontal period. The peak detecting section 124 outputs a signal resulting from the noise elimination to the subtractor 122 at the subsequent stage. It is noted that the subtractor 122 and the controller 123 operate in the same manner as in the first embodiment.

In this manner, in the second embodiment, even when noise is included in the voltage monitor signal input to the voltage controller 120 through the voltage monitor line 102, the PID control can be executed with the noise eliminated, and therefore, control output variation due to the noise can be suppressed.

Although the voltage controller 120 includes the peak detecting section 124 as the noise eliminator in the configuration of the present embodiment, a configuration in which a bottom detecting section is included instead of the peak detecting section 124 for eliminating high frequency noise may be employed.

### Third Embodiment

In a third embodiment, a configuration in which the voltage controller 120 includes a smoothing section 125 as the noise eliminator will be described.

It is noted that the whole configuration of the liquid crystal display device will not be described because the configuration is the same as that of the first embodiment.

FIG. 9 is a block diagram illustrating a configuration of the voltage controller 120 according to the third embodiment. The voltage controller 120 of the third embodiment includes the smoothing section 125 corresponding to the noise eliminator in addition to the impedance converter 121, the subtractor 122, and the controller 123 described above.

The smoothing section 125 is, for example, a low pass filter, and subjects the signal output from the impedance converter 121 to smoothing processing to eliminate high frequency noise included in the signal. Since high frequency noise occurs mainly in a cycle of a horizontal period, a time constant of the low pass filter is preferably set to a time sufficiently longer than the cycle of the horizontal period. The smoothing section 125 outputs a signal resulting from the noise elimination to the subtractor 122 at the subsequent stage. It is noted that the subtractor 122 and the controller 123 operate in the same manner as in the first embodiment.

In this manner, in the third embodiment, even when noise is included in the voltage monitor signal input to the voltage controller 120 through the voltage monitor line 102, the PID control can be executed with the noise eliminated, and therefore, control output variation due to the noise can be suppressed.

Although the configuration in which the smoothing processing is performed using a low pass filter in the present embodiment, a configuration in which the smoothing processing is performed by obtaining a moving average of a plurality of continuous sampling values after A/D conversion may be employed.

### Fourth Embodiment

In a fourth embodiment, a configuration in which information obtained in a previous frame is used for predicting a control value to be used in a next frame will be described.

It is noted that the whole configuration of the liquid crystal display device will not be described because the configuration is the same as that of the first embodiment.

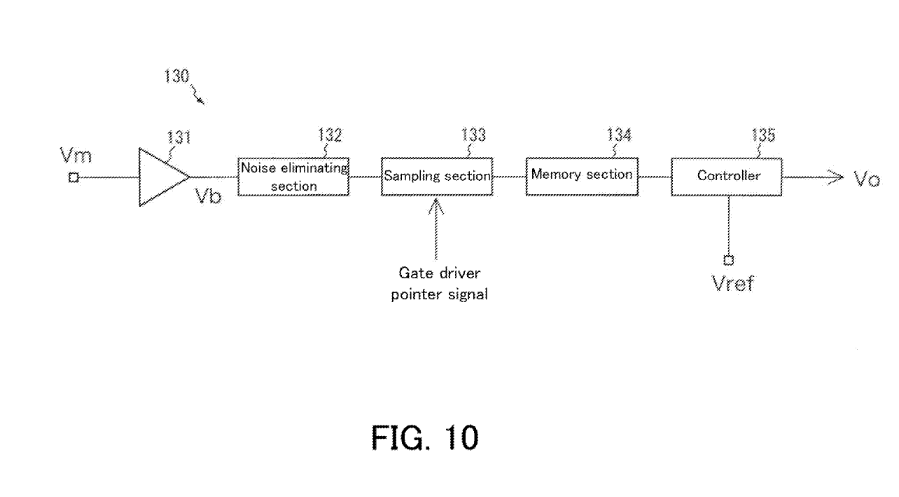

FIG. 10 is a block diagram illustrating a configuration of a power supply section according to a fourth embodiment. The timing controller 100 according to the fourth embodiment includes, in the same manner as in the first embodiment, the power supply section 110 outputting the applied voltages to be applied to the gate drivers 2 and the source drivers 3, and a voltage controller 130 controlling voltage values of the applied voltages output by the power supply section 110.

The voltage controller 130 includes an impedance converter 131, a noise eliminating section 132, a sampling section 133, a memory section 134, and a controller 135.

The impedance converter 131 is, for example, a voltage follower, and converts the voltage monitor signal input through the voltage monitor line 102 into a signal at low impedance. The noise eliminating section 132 is, for example, a peak detector, a bottom detector, a low pass filter or the like, and eliminates noise from the signal output from the impedance converter 131.

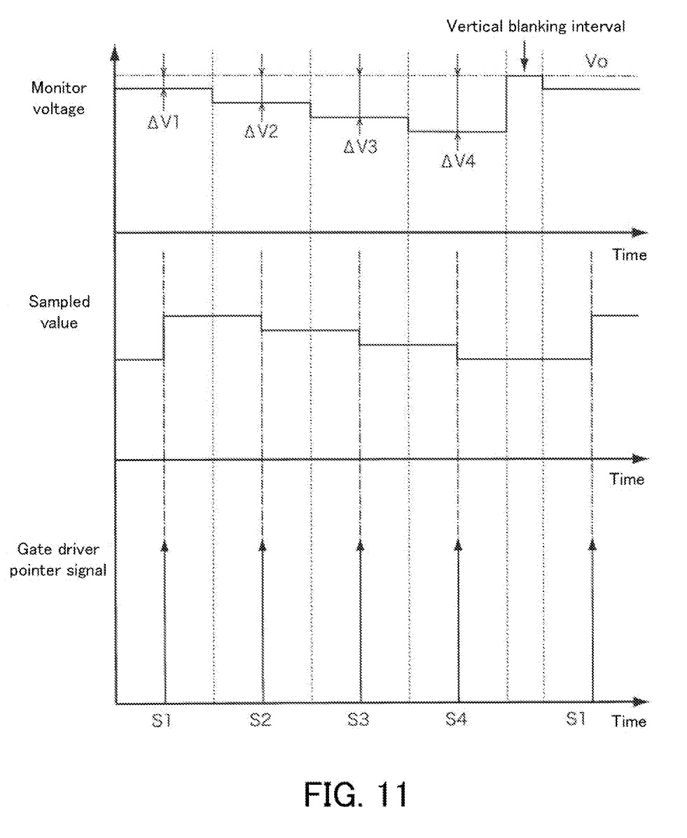

The sampling section 133 is, for example, an AD converter. To the sampling section 133, the signal from which noise has been eliminated by the noise eliminating section 132, and a gate driver pointer signal indicating the operation timing of each of the gate drivers 2A to 2D are input. FIG. 11 is a waveform diagram used for describing sampling timing of the monitor voltage. In the present embodiment, the sampling timing indicated by the gate driver pointer signal is set to timing (for example, timing in the middle of each of periods S1 to S4) shifted from the timing of switching the gate driver performing the scanning operation. The sampling section 133 samples the signal input from the noise eliminating section 132 at the timing indicated by the gate driver pointer signal, and outputs the sampled signal to the memory section 134 at the subsequent stage. A value sampled by the sampling section 133 is recorded in the memory section 134.

The controller 135 determines, in accordance with a difference ΔV between the sampled value Vs recorded in the memory section 134 and the precedently set target value Vref, the value Vo of the applied voltage to each of the gate drivers 2A to 2D to be supplied in the next frame. When it is assumed, for example, that the value of the applied voltage supplied in the previous frame is Vo(n-1), and that the difference between the sampled value Vs and the target value Vref is ΔVx(n-1), the voltage controller can calculate the value Vo(n) of the applied voltage to be supplied in the next frame in accordance with Vo(n)=Vo(n-1)+K·ΔV(n-1). Here, K is preferably a constant no greater than 1. The voltage controller 130 outputs, to the power supply section 110, a signal using, as the control output, the value Vo(n) calculated by the controller 135.

Based on the control output supplied from the voltage controller 130, the power supply section 110 outputs, at the timing of each of the gate drivers 2A to 2D performing the scanning operation, the applied voltage to each of the gate drivers 2A to 2D to have the voltage value of Vo(n). Owing to this configuration, in the present embodiment, the value Vm of the monitor voltage monitored through the voltage monitor line 102 is controlled to be the prescribed target voltage value Vref.

In this manner, according to the fourth embodiment, even when the wiring resistance within the TFT substrate 10 is varied owing to the size of the liquid crystal display panel 1 and variation caused in production of the panel, the applied voltages applied when the gate drivers 2A to 2D perform the scanning operation can be controlled to be constant without precedently setting the values of the applied voltages to the gate drivers 2A to 2D at the design stage. As a result, in the present embodiment, the influence of a voltage drop caused due to the wiring resistance within the TFT substrate 10 can be reduced, and screen display quality can be improved.

Besides, when the PID control is performed as described in the first to third embodiments, a ripple voltage is actually generated as illustrated in FIG. 7 in a period from the switching timing of each of the gate drivers 2A to 2D in each of the periods S1 to S4 until response and convergence of the control voltage Vo. In the fourth embodiment, however, the value Vo of the control voltage to be used in the next frame can be predicted using the information obtained in the previous frame, and hence an optimal voltage is supplied immediately after switching each of the gate drivers 2A to 2D without generating a ripple voltage during the control response period, and thus, stable voltage control can be carried out.

Besides, when the sampling section 133 performs the sampling at intermediate timing shifted from edge timing of a gate pulse of each of the gate drivers 2A to 2D successively selecting and driving the gate line 11, sampling can be performed with high frequency noise occurring in the vicinity of the edge of the gate pulse eliminated, and therefore, the noise eliminating section 132 is not always necessary in the fourth embodiment.

The embodiments disclosed herein are to be considered in all respects as only illustrative and not restrictive. The scope of the invention is, therefore, indicated by the appended claims rather than by the foregoing description, and all changes which come within the meaning and range of equivalency of the claims are to be embraced within their scope.

The following are disclosed with respect to the aforementioned embodiments.

A liquid crystal display device according to one embodiment of the present invention includes: a display panel including a substrate having a surface on which a plurality of pixels are formed in a matrix defined by a first direction and a second direction, a plurality of gate lines are disposed along the first direction, and a plurality of source lines are disposed along the second direction; a plurality of gate drivers connected to the gate lines on a first side of the substrate; a plurality of source drivers connected to the source lines on a second side of the substrate; a power supply section; and a single first line used for applying, to each of the gate drivers, a supply voltage for operating the plurality of gate drivers, and the plurality of gate drivers are disposed on the first side of the substrate along the second direction, and are connected to the power supply section through the first line in a near-to-far order from the power supply section, the first line is formed, in a partial section thereof, on the surface of the substrate, and the liquid crystal display device includes a voltage controller controlling, to a prescribed voltage value, a value of an applied voltage to the gate driver furthest from the power supply section.

According to the present embodiment, the value of the applied voltage to the furthest gate driver, among the plurality of gate drivers connected to the power supply section successively in the near-to-far order from the power supply section through the first line, is controlled to the prescribed voltage value, and thus, influence of a voltage drop occurring in each of the gate drivers due to wiring resistance of the first line can be reduced, and display quality degradation can be avoided.

In the present embodiment, the voltage controller preferably changes an output voltage of the power supply section in accordance with a difference between the prescribed voltage value and the value of the applied voltage.

According to the present embodiment, since the output voltage of the power supply section is changed in accordance with the difference between the prescribed voltage value and the value of the applied voltage to the furthest gate driver, there is no need to set, at the design stage of the liquid crystal display device, the value of the applied voltage to each gate driver by statistic processing or the like, but the applied voltage to each gate driver can be appropriately controlled based on a value of the voltage actually applied to the furthest gate driver.

In a preferable embodiment, the voltage controller may include: a recording section in which the prescribed voltage value is recorded; and a controller that calculates a difference between the prescribed voltage value received from the recording section and the value of the applied voltage, and outputs, to the power supply section, a signal for adding a voltage according with the calculated difference to the output voltage of the power supply section.

According to the present embodiment, the difference between the prescribed voltage value and the value of the applied voltage to the furthest gate driver is calculated, and the signal for adding the voltage according with the calculated difference to the output voltage from the power supply section is output to the power supply section. Therefore, there is no need to set, at the design stage of the liquid crystal display device, the value of the applied voltage to each gate driver by the statistic processing or the like, but the power supply section can be controlled so as to appropriately supply the applied voltage to each gate driver based on a value of the voltage actually applied to the furthest gate driver.

In a preferable embodiment, the voltage controller may include: a recording section in which the prescribed voltage value is recorded, and the value of the applied voltage is recorded during a first scanning period; and a controller that calculates a difference between the prescribed voltage value received from the recording section and the value of the applied voltage, and outputs, to the power supply section, a changing signal for changing a value of the output voltage of the power supply section in a scanning period following the first scanning period to a value obtained by adding the calculated difference to the value of the applied voltage used in the first scanning period.

According to the present embodiment, the difference between the prescribed voltage value and the value of the applied voltage to the furthest gate driver is calculated, and a signal for outputting, in the scanning period following the first scanning period, a voltage obtained by adding a voltage according with the calculated difference to the output voltage output in the first scanning period is output, and therefore, an appropriate applied voltage can be supplied to each gate driver immediately after switching the gate driver.

In the present embodiment, in the recording section, the value of the applied voltage is preferably recorded at least once in a period when each of the plurality of gate drivers is driven within the first scanning period, and the controller preferably outputs, to the power supply section, the changing signal over a period when a corresponding one of the gate drivers is driven in the scanning period following the first scanning period.

According to the present embodiment, the value of the applied voltage is recorded at least once in the period when each gate driver is driven, the difference between the prescribed voltage value and the value of the applied voltage to the furthest gate driver is calculated, and the voltage obtained by adding the voltage according with the calculated difference to the output voltage output in the first scanning period is output in the following scanning period over a period when the corresponding one of the gate drivers is driven. Therefore, for example, when the value of the applied voltage to the furthest gate driver is obtained in a period excluding an edge portion of a gate pulse, influence of noise included in the gate pulse can be avoided.

In the present embodiment, the voltage controller may further include an impedance converter that generates the value of the applied voltage by performing impedance conversion of a signal obtained from a wiring region, included in the first line, used for applying the voltage to the furthest gate driver.

According to the present embodiment, since the impedance converter is included, for example, the applied voltage to the furthest gate driver can be received at high impedance to be converted into a voltage at low impedance, and therefore, the value of the applied voltage to the furthest gate driver can be accurately measured.

In the present embodiment, the voltage controller may further include a noise eliminator eliminating noise of a value obtained by the impedance conversion.

According to the present embodiment, since the noise eliminator eliminating noise of the value obtained by the impedance conversion is included, for example, noise of an edge portion of a gate pulse can be eliminated to accurately measure the value of the applied voltage to the furthest gate driver.

In the present embodiment, a second line connecting the voltage controller to the wiring region is preferably further included.

According to the present embodiment, since the second line connecting the voltage controller to the wiring region used for applying the voltage to the furthest gate driver is included, the value of the applied voltage to the furthest gate driver can be obtained through the second line.

In the present embodiment, the second line may be formed, in a partial section thereof, on the surface of the substrate.

According to the present embodiment, since the first line and the second line are formed on the substrate, there is no need to provide a gate substrate on which a line used for applying a voltage to each gate driver is formed, and thus, a bezel can be narrowed.

A method for driving a liquid crystal display device according to one embodiment is a method for driving a liquid crystal display device including: a display panel including a substrate having a surface on which a plurality of pixels are formed in a matrix defined by a first direction and a second direction, a plurality of gate lines are disposed along the first direction, and a plurality of source lines are disposed along the second direction; a plurality of gate drivers connected to the gate lines on a first side of the substrate; a plurality of source drivers connected to the source lines on a second side of the substrate; a power supply section; and a single first line used for applying, to each of the gate drivers, a supply voltage for operating the plurality of gate drivers, the plurality of gate drivers being disposed on the first side of the substrate along the second direction, and being connected to the power supply section through the first line in a near-to-far order from the power supply section, the first line being formed, in a partial section thereof, on the surface of the substrate, and the method includes: calculating a difference between a value of an applied voltage to the gate driver furthest from the power supply section and a prescribed voltage value; and controlling the value of the applied voltage to the prescribed voltage value by changing an output voltage of the power supply section in accordance with the calculated difference.

According to the present embodiment, the value of the applied voltage to the furthest gate driver, among the plurality of gate drivers connected to the power supply section successively in the near-to-far order from the power supply section through the first line, is controlled to the prescribed voltage value, and thus, influence of a voltage drop occurring due to wiring resistance of the first line connected to each of the gate drivers can be reduced, and display quality degradation can be avoided.

### REFERENCE SIGNS LIST

1 liquid crystal display panel
2 (2A to 2D) gate driver
3 source driver
10 TFT substrate
11 gate line
12 source line
13 pixel
20, 30 film substrate
31 source substrate
32 flat cable
100 timing controller
101 gate power supply line
102 voltage monitor line
110 power supply section
120, 130 voltage controller
121, 131 impedance converter
122 subtractor
123, 135 controller
124 peak detecting section
125 smoothing section
132 noise eliminating section
133 sampling section
134 memory section

1. A liquid crystal display device, comprising:
a display panel including a substrate having a surface on which a plurality of pixels are formed in a matrix defined by a first direction and a second direction, a plurality of gate lines are disposed along the first direction, and a plurality of source lines are disposed along the second direction;
a plurality of gate drivers connected to the gate lines on a first side of the substrate;
a plurality of source drivers connected to the source lines on a second side of the substrate;
a power supply section; and
a single first line used for applying, to each of the gate drivers, a voltage for driving the plurality of gate drivers, wherein
the plurality of gate drivers are disposed on the first side of the substrate along the second direction, and are connected to the power supply section through the first line in a near-to-far order from the power supply section,
the first line is formed, in a partial section thereof, on the surface of the substrate, and
the liquid crystal display device comprises a voltage controller controlling, to a prescribed voltage value, a value of an applied voltage to the gate driver furthest from the power supply section.

2. The liquid crystal display device according to claim 1, wherein
the voltage controller changes an output voltage of the power supply section in accordance with a difference between the prescribed voltage value and the value of the applied voltage.

3. The liquid crystal display device according to claim 2, wherein
the voltage controller includes:
a recording section in which the prescribed voltage value is recorded; and
a controller that calculates a difference between the prescribed voltage value received from the recording section and the value of the applied voltage, and outputs, to the power supply section, a signal for adding a voltage according with the calculated difference to the output voltage of the power supply section.

4. The liquid crystal display device according to claim 2, wherein
the voltage controller includes:
a recording section in which the prescribed voltage value is recorded, and the value of the applied voltage is recorded during a first scanning period; and
a controller that calculates a difference between the prescribed voltage value received from the recording section and the value of the applied voltage, and outputs, to the power supply section, a changing signal for changing a value of the output voltage of the power supply section in a scanning period following the first scanning period to a value obtained by adding the calculated difference to the value of the applied voltage used in the first scanning period.

5. The liquid crystal display device according to claim 4, wherein
in the recording section, the value of the applied voltage is recorded at least once in a period when each of the plurality of gate drivers is driven within the first scanning period, and
the controller outputs, to the power supply section, the changing signal over a period when a corresponding one of the gate drivers is driven in the scanning period following the first scanning period.

6. The liquid crystal display device according to claim 2, wherein
the voltage controller further includes an impedance converter that generates the value of the applied voltage by performing impedance conversion of a signal obtained from a wiring region, included in the first line, used for applying the voltage to the furthest gate driver.

7. The liquid crystal display device according to claim 6, wherein
the voltage controller further includes a noise eliminator eliminating noise of a value obtained by the impedance conversion.

8. The liquid crystal display device according to claim 6, further comprising
a second line connecting the voltage controller to the wiring region.

9. A method for driving a liquid crystal display device including: a display panel including a substrate having a surface on which a plurality of pixels are formed in a matrix defined by a first direction and a second direction, a plurality of gate lines are disposed along the first direction, and a plurality of source lines are disposed along the second direction; a plurality of gate drivers connected to the gate lines on a first side of the substrate; a plurality of source drivers connected to the source lines on a second side of the substrate; a power supply section; and a single first line used for applying, to each of the gate drivers, a voltage for driving the plurality of gate drivers, the plurality of gate drivers being disposed on the first side of the substrate along the second direction, and being connected to the power supply section through the first line in a near-to-far order from the power supply section, the first line being formed, in a partial section thereof, on the surface of the substrate, the method comprising:
calculating a difference between a value of an applied voltage to the gate driver furthest from the power supply section and a prescribed voltage value; and
controlling the value of the applied voltage to the prescribed voltage value by changing an output voltage of the power supply section in accordance with the calculated difference.

10. The liquid crystal display device according to claim 8, wherein
the second line is formed, in a partial section thereof, on the surface of the substrate.
